(19) United States
(12) Patent Application Publication
(10) Pub. No.: US 2026/0189153 A1
(43) Pub. Date: Jul. 2, 2026

(54) INVERTER UNIT AND ELECTRIC COMPRESSOR COMPRISING SAME

(71) Applicant: Hanon Systems, Daejeon (KR)

(72) Inventors: Jae Kyoung Jin, Daejeon (KR); Tae Hyoung Kim, Daejeon (KR); Hee Soo Won, Daejeon (KR); Jae Won Lee, Daejeon (KR)

(21) Appl. No.: 19/126,882

(22) PCT Filed: Sep. 14, 2023
(86) PCT No.: PCT/KR2023/013766

§ 371 Date: Mar. 23, 2026

(30) Foreign Application Priority Data
Nov. 2, 2022 (KR) 10-2022-0144630

(51) Int. Cl. H02M 7/00; F04C 18/02; F04C 29/00; H02K 11/33

(52) U.S. Cl. CPC H02M 7/003; F04C 18/0215; F04C 29/0085; H02K 11/33; F04C 2240/403

(57) ABSTRACT

An inverter unit and an electric compressor including the same are disclosed. According to the embodiments, simultaneous stable fixing of inverter elements, securing of an insulation distance, and heat dissipation facilitate the stable operation of an electric compressor.

### BACKGROUND OF THE INVENTION

### Field of the Invention

The present disclosure is intended for the stable insulation and operation of an inverter element. More particularly, the present disclosure relates to an inverter unit and an electric compressor including the inverter unit.

### Description of the Related Art

In recent years, increasing reliance on electrical and electronic systems in motor vehicles has stimulated research and development on an electric compressor driven by electricity using a motor. The output of the electric motor compressor is controlled via an inverter.

However, an operating feature of the electricity-driven compressor is that its motor and inverter inevitably generate high-temperature heat, and the heat generation of the inverter directly affects the performance of the motor and inverter.

Accordingly, various strategies to address the heat generation issue are proposed.

In general, a direct cooling method using coolant is employed to cool the motor. In this method, coolant directly circulates through the part where the motor is mounted inside the main housing to absorb the heat generated while the motor is running.

However, applying the direct cooling method of circulating coolant through an inverter like a motor may comprise the durability of the switching element of the inverter.

For example, a heat-generating switching element (referred to as an inverter element hereinafter) such as an insulated gate bipolar mode transistor (IGBT) included in the inverter in large numbers has limited durability, so the direct cooling method is virtually a non-viable strategy.

Conventional inverter elements and the fixing state thereof will be described with reference to drawings. FIG. 1 is a perspective view of an inverter housing applied to a conventional electric compressor, and FIG. 2 is an enlarged view of the inverter elements shown in FIG. 1.

FIGS. 1 and 2 show that a seating surface 5a is formed inside an inverter housing 5 and a plurality of inverter elements are mounted inside the inverter housing 5 such that the inverters'side facing the seating surface 5a is in contact with the seating surface 5a in the conventional electric compressor. The inverter housing 5 is configured to adhere to a suction chamber (not shown) formed inside the main housing 4.

A part of the heat generated from the inverter element 2 is conducted to the suction chamber of the main housing 4 through the inventor housing 5 and the side of the inverter elements in contact with the inverter housing 5.

A part of the heat generated from the inverter element 2 is dissipated by the air cooling method utilizing the convection of air inside the inverter housing 5 to cool the inverter element 2.

In this configuration, the heat of the inverter element 2 moves to the inverter housing 5 only through the seating surface 5a in contact with the inverter element 2, so heat dissipation may not be sufficiently effective.

In addition, the structure of a plurality of inverter elements 2 being in contact with the seating surface 5a complicates the manufacturing process and makes modularization beyond reach, so mass-producing the product is challenging.

FIG. 3 shows that a method of fixing the inverter element 2 through a clamp 8 having one side fixed to a fixing bolt 7 mounted in the inverter housing 5 has been used in recent years.

However, the inverter element 2 and the clamp 8 have different heights, so the surface pressure applied to the inverter element 2 remains uneven and foreign matters accumulate on the heat-dissipating surface of the inverter element 2. Accordingly, measures to resolve the issues are required.

### SUMMARY OF THE INVENTION

An aspect of the present disclosure is directed at providing an inverter unit and an electric compressor including the inverter unit with boosted insulation performance of an inverter element and improved coupling relationship between a fixing member, an inverter housing, and a motor housing.

According to an embodiment of the present disclosure, an inverter unit may include a plurality of inverter elements 12 mounted on a seating surface 6a of an inverter housing 6, a fixing member 30 partially inserted into a motor housing 20 via the plurality of inverter elements 12 and the inverter housing 6 to fix the plurality of inverter elements 12 to the seating surface 6a individually, and an insulation member 40 coupled to the fixing member 30 and subsequently inserted into the inverter housing 6.

The fixing member 30 may further include a step portion 32 stepped radially inward.

The step portion 32 may be positioned above the inverter housing 6 in the state where the fixing member 30 is mounted in the inverter housing 6.

The underside of the fixing member 30 may extend horizontally.

The underside of the fixing member 30 may extend in a cone shape.

The insulation member 40 may include a body portion 42 forming the overall appearance and a protrusion portion 44 extending from the upper side of the body portion 42 via the topside of the inverter housing 6 to be coupled to the fixing member 30 and subsequently engage the step portion 32.

The protrusion portion 44 may extend radially outward to a first insulation thickness t to secure insulation distance.

In the plurality of inverter elements 2, a bushing 14 may be inserted into a through hole 12a into which the fixing member 30 is inserted, and the radial length of the body portion 42 is shorter than that of the bushing 14. In the embodiments of the present disclosure, the inverter elements may be stably fixed and heat may be conducted to the low-temperature motor housing through a structural change of the fixing member.

An insulator 50 may be provided between the inverter element 12 and the inverter housing 6, and the topside of the body portion 42 may remain in surface contact with the underside of the insulator 50.

The inverter housing 6 may include a first insertion hole 6d into which the fixing member 30 is inserted, an extension portion 6c extending to a predetermined length from the underside of the inverter housing 6 toward the motor housing 20 relative to the first insertion hole 6d and including a first thread 6bb formed inside, and a first groove portion 6b into which the insulation member 40 is inserted.

The extension portion 6c may extend beyond the underside of the fixing member 30.

A second thread 34 engaging the first thread 6bb of the extension portion 6c in helical coupling may be formed in the fixing member 30.

The motor housing 20 includes a second groove portion 24 into which the inverter housing 6 and the extension portion 6c are inserted.

According to an embodiment of the present disclosure, an electric compressor includes a housing 100, a motor portion 200 provided in the housing 100, a compressor unit 300 provided with a compression unit driven by the motor portion 200, and an inverter unit 10 coupled to the compressor unit 300, wherein the inverter unit 10 include an insulation member 40 coupled to a fixing member 30, partially inserted into the motor housing 20 via a plurality of inverter elements 12 and an inverter housing 6, and subsequently inserted into the inverter housing 6 to fix the plurality of inverter elements 12 mounted on a seating surface 6a of the inverter housing 6 to the seating surface 6a individually.

The fixing member 30 may further include a step portion 32 stepped radially inward.

The insulation member 40 may include a body portion 42 forming the overall appearance and a protrusion portion 44 extending from the upper side of the body portion 42 via the topside of the inverter housing 6 to be coupled to the fixing member 30 and subsequently engage the step portion 32.

The protrusion portion 44 may extend radially outward to a first insulation thickness t to secure an insulation distance.

An insulator 50 may be provided between the inverter element 12 and the inverter housing 6, and the topside of the body portion 42 remains in surface contact with the underside of the insulator 50.

The inverter housing 6 may include a first insertion hole 6d into which the fixing member 30 is inserted, an extension portion 6c extending to a predetermined length from the underside of the inverter housing 6 toward the motor housing 20 relative to the first insertion hole 6d and including the first thread 6bb formed inside, and a first groove portion 6b into which the insulation member 40 is inserted.

The extension portion 6c may extend beyond the underside of the fixing member 30.

A second thread 34 engaging the first thread 6bb of the extension portion 6c in helical coupling may be formed in the fixing member 30.

The motor housing 20 may include a second insertion groove hole 22 into which the inverter housing 6 is inserted and a second groove portion 24 into which the extension portion 6c is inserted.

### BRIEF DESCRIPTION OF THE DRAWINGS

FIG. 1 is a perspective view of an inverter housing applied to a conventional electric compressor.

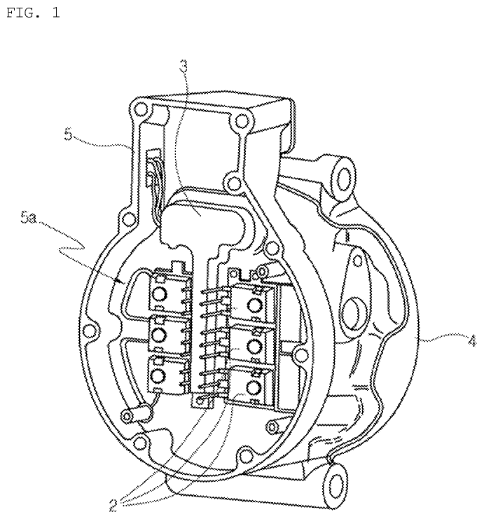

FIG. 2 is an enlarged view of the inverter elements shown in FIG. 1.

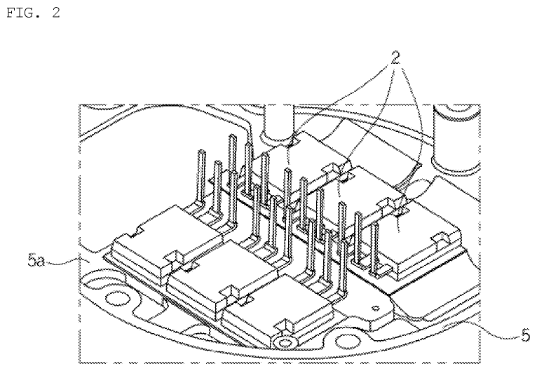

FIG. 3 is a cross-sectional view of an embodiment used to fix a conventional inverter element.

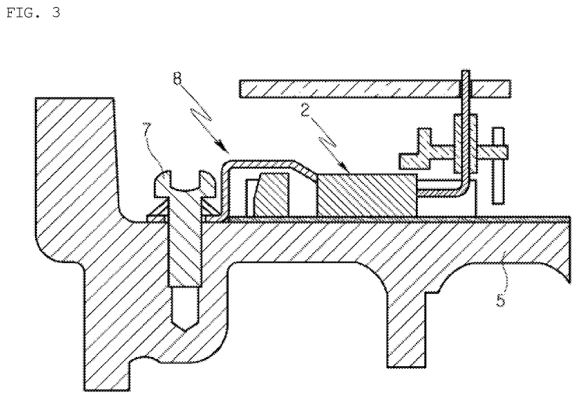

FIG. 4 is a perspective view of an electric compressor according to an embodiment.

FIG. 5 is a longitudinal view of the electric compressor shown in FIG. 4

FIG. 6 is a plan view of an inverter element in a mounted state according to an embodiment.

FIG. 7 is an exploded cross-sectional view of an inverter element and components fixed by a fixing member according to an embodiment.

FIG. 8 is an assembled cross-sectional view of the inverter element and components shown in FIG. 7

FIG. 9 is a view of a fixing member according to another embodiment.

### DETAILED DESCRIPTION OF THE INVENTION

The advantages and features of the present disclosure and methods for achieving them will be made clear by referring to the embodiments described below in detail along with the accompanying drawings. However, the present disclosure is not limited to the embodiments disclosed below and will be implemented in various forms different from each other. The embodiments are provided only to complete the disclosing of the present disclosure and to fully convey the scope of the present disclosure to those skilled in the art to which the present disclosure pertains. The present disclosure is defined only by the scope of the claims. Like reference numerals designate like elements throughout the specification.

When one component is referred to as being “connected to” or “coupled to” another component, it indicates both cases where one component is directly connected or coupled to another component and there is still another component in between. In contrast, when one component is referred to as being “directly connected to” or “directly coupled to”, it indicates no other component in between. “And/or” includes any individual component mentioned and any combination thereof.

The terms in the present specification are used to describe embodiments and are not intended to limit the disclosure. Singular expressions include plural expressions unless specified otherwise in the present specification. When it comes to “comprises” and/or “comprising”, used herein, the mentioned component, step, operation, and/or element do not preclude the presence of one or more of other components, steps, operations, and/or elements.

The terms including ordinal numbers such as first, second, and the like may be used to describe various components, but the components are not to be limited by the terms. The terms may only be used to distinguish one component from the other.

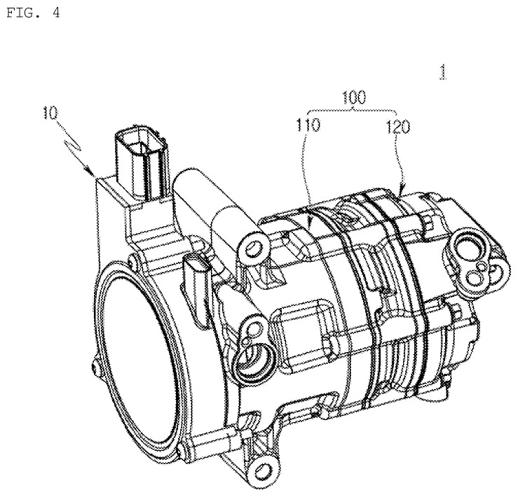

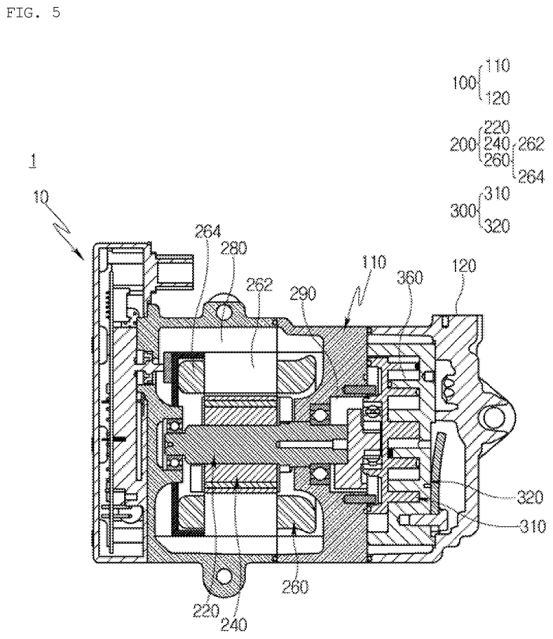

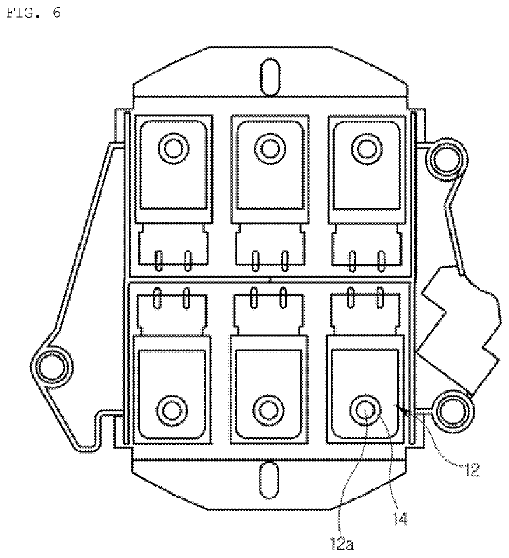

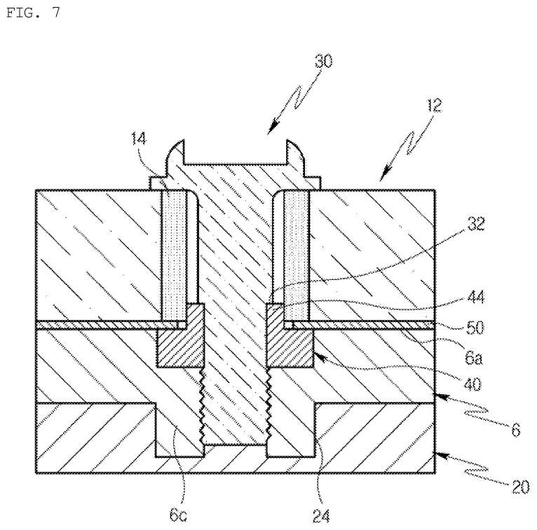

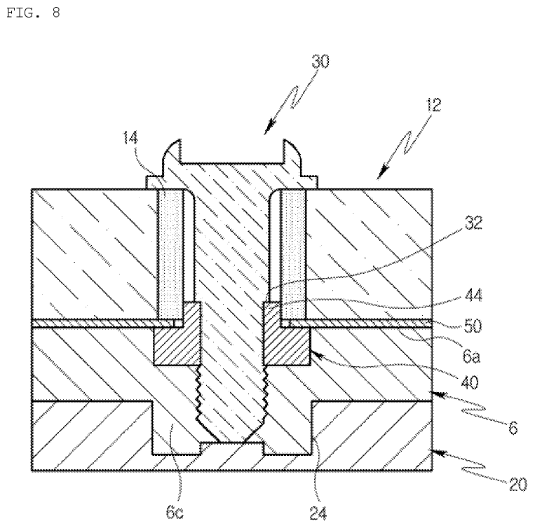

An inverter unit and an electric compressor including the inverter unit according to an embodiment of the present disclosure will be described with reference to the drawings. FIG. 4 is a perspective view of an electric compressor according to an embodiment, FIG. 5 is a longitudinal view of the electric compressor shown in FIG. 4, FIG. 6 is a view of an inverter element in a mounted state according to an embodiment, FIG. 7 is an exploded cross-sectional view of an inverter element and components fixed by a fixing member according to an embodiment, and FIG. 8 is an assembled cross-sectional view of the inverter and components shown in FIG. 7.

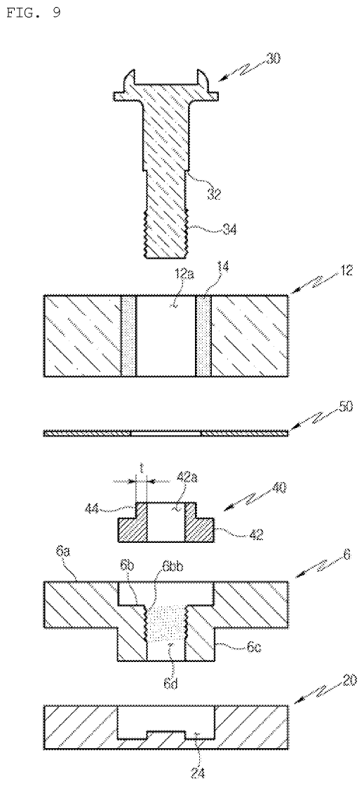

FIGS. 4 to 9 show that the electric compressor 1 according to an embodiment includes a housing 100, a motor portion 200, a compressor unit 300, and an inverter unit 10.

The housing 100 forms the overall appearance of the electric compressor and, in the present embodiment, includes a front housing 110 and a rear housing 120.

The monitor portion 200 is provided in the front housing 110 and a compression unit 300 provides power for suppressing coolant. The motor portion 200 includes a rotor 240 coupled to a rotation shaft 220 rotatably mounted in the center of the front housing 110 and a stator 260 fixed to the front housing 110 to be disposed outside the rotor 240 in the radial direction. The stator 260 includes a stator core 262 and a coil 264 wound to the stator core 262.

It is to be noted that the compression unit 300 includes a slewing scroll 310 and a fixed scroll 320, and the front housing 110 includes a suction chamber 280 and a back pressure chamber 290.

The compression unit 300 is provided inside the rear housing 120.

The inverter unit 10 is provided outside the housing 100 but coupled to the compression unit 300 on the opposite side from the motor 200. The inverter unit 10 is electrically connected to the motor portion 200 to apply power to and control the operation of the motor portion 200 through the power and control signals transmitted from outside.

More specifically, the stator 260 creates an electromagnetic field by the power supplied from the inverter unit 10, and as the rotor 240 rotates by the electromagnetic field created by the stator 260, a rotational force to drive the compression unit 300 is generated.

The inverter unit 10 is provided with a printed circuit board on which a plurality of inverter elements 12 are mounted and includes an inverter body coupled to one side of the housing 100 and an inverter cover facing the inverter body to be coupled thereto.

In the plurality of inverter elements 12, a bushing 14 is inserted into a through hole 12a into which the fixing member 30 is inserted, and the bushing 14 is made of a plastic insulation material.

When the plurality of inverter elements 12 are mounted in the inverter unit 10, the inverter unit 10 underwent a structural change through the fixing member 30 to secure withstand voltage performance and improve the heat dissipation performance through the inverter housing 6.

To this end, the present embodiment includes a plurality of inverter elements 12 mounted on a seating surface 6a of an inverter housing 6, a fixing member 30 partially inserted into a motor housing 20 via the plurality of inverter elements 12 and the inverter housing 6 to fix the plurality of inverter elements 12 to the seating surface 6a individually, and an insulation member 40 coupled to the fixing member 30 and subsequently inserted into the inverter housing 6.

In particular, in the present embodiment, the fixing member 30 may individually fix the plurality of inverter elements 12 to allow complete and lasting fixing to the inverter housing 6 in an adhered state, so uniform surface pressure may be stably maintained.

When fixing the plurality of inverter elements 12, the fixing member 30 is coupled in a state where its lower end (at 6 o'clock position) is in contact with the inner side of the motor housing 20 so that the high-temperature heat energy generated from the plurality of inverter elements 12 is rapidly conducted to the low-temperature motor housing 20 to induce cooling.

In this case, the heat of the plurality of inverter elements 12 is not dissipated only to the inverter housing 6. Contact with the motor housing 20 that maintains contact with the low-temperature coolant simultaneously allows transfer and cooling of the high-temperature heat energy through conduction, thereby improving the cooling performance of the plurality of inverter elements 12.

The fixing member 30 further includes a step portion 32 stepped radially inward. The step portion 32 is formed to fix an insulation member 40, described below, after being inserted into the fixing member 30. In other words, the insulation member 40 is fixed at the position where the step portion 32 is formed after being inserted around the fixing member 30, thereby facilitating stable insertion.

The step portion 32 is positioned above the inverter housing 6 in the state where the fixing member 30 is mounted in the inverter housing 6. The step portion 32 is positioned at that position to secure a mounting position of the insulation member 40 through the adjustment of the insertion position of the insulation member 40.

According to the embodiment, the underside of the fixing member 30 extends horizontally to maintain the surface contact state with the motor housing 20. When the fixing member 30 is in surface contact with the motor housing 20 in this manner, heat from the plurality of inverter elements 12 is conducted to the motor housing 20 through the underside of the fixing member 30 so that the inverter elements 12 are cooled more rapidly.

According to the embodiment, the insulation member 40 described below is provided to stably mount the fixing member 30 on the motor housing 20 via the inverter housing 6 after the fixing member 30 is inserted into the inverter element 12.

The insulation member 40 is inserted inside the inverter housing 6 to secure the insulation distance of the inverter element 12 stably. The insulation distance refers to a horizontal distance from the side of the fixing member 30 to an insulator 50.

A shorter insulation distance allows more stable operation of the inverter unit even under a high-voltage environment of 800 volts or more by preventing malfunctions or failures caused by damage to the insulation and securing the withstand voltage performance. In addition, the durability of the electric compressor is preserved even when the compressor is operated for an extended period so that the financial burden on the user from repairs and replacements may be reduced.

The insulation member 40 includes a body portion 42 forming the overall appearance and a protrusion portion 44 extending from the upper side of the body portion 42 via the topside of the inverter housing 6 to be coupled to the fixing member 30 and subsequently engage the step portion 32.

The body portion 42 is formed in a ring shape with a hole 42a in the center for the fixing member 30 to be inserted thereinto, and the protrusion portion 44 is formed upward (toward noon position) from the topside of the body portion 42.

The protrusion portion 44 is coupled face to face with the step portion 32 of the fixing member 30 and thus facilitates stable mounting of the insulation member 40. The insulation distance from the inverter element 12 may be set as a function of the radial thickness t of the protrusion portion 44.

For example, the protrusion portion 44 extends from the side of the fixing member 30 to a first insulation thickness t so that the insulation distance between the fixing member 30 and the insulator 50 described below is maintained stably. In this case, the insulation performance may be stably preserved even when the inverter unit 10 is operated in a high-voltage environment.

The fixing member 30 may be manufactured in advance to ensure that the first insulation thickness is equal to t as shown in the diagram or greater than t to achieve more stable insulation.

The insulator 50 is provided between the inverter element 12 and the inverter housing 6, and the topside of the body portion 42 remains in surface contact with the underside of the insulator 50. The insulator 50 is provided to insulate the inverter element 12.

The inverter housing 6 is closely coupled face to face with the motor housing 20 so that an extension portion 6c is formed for heat dissipation of the inverter element 12 as shown in the drawing.

The inverter housing 6 includes a first insertion hole 6d into which the fixing member 30 is inserted, an extension portion 6c extending to a predetermined length from the underside of the inverter housing 6 toward the motor housing 20 relative to the first insertion hole 6d and including the first thread 6bb formed inside, and a first groove portion 6b into which the insulation member 40 is inserted.

The extension portion 6c extends to a predetermined length toward the motor housing 20 relative to the first insertion hole 6d, and the first groove portion 6b is formed in the upper portion. The extension portion 6c may be formed in various manners other than the length and thickness shown in the drawing.

The extension portion 6c extends beyond the underside of the fixing member 30 to maintain the stable coupling and fixed state of the fixing member 30, thereby preventing issues caused by loosening.

A second thread 34 engaging engaging the first thread of the extension portion 6c in helical coupling is formed in the fixing member 30 to allow the fixing member 30 to be stably coupled to the inverter housing 6.

The motor housing 20 includes a second groove portion 24 into which the inverter housing 6 and the extension portion 6c are inserted. The surface contact between the second groove portion 24 and the undersides of the extension portion 6c of the inverter housing 6 and the fixing member 30 allows additional heat dissipation through heat conduction so that the high-temperature heat of the inverter element 12 may be dissipated more stably.

Accordingly, in the present embodiment, the coupling relationship between the fixing member 30, inverter housing 6, and motor housing 20 facilitates stable heat dissipation even when the extended operation of the inverter unit 10 causes the inverter element 12 to operate at a high temperature.

In the present embodiment, the seating surface 6a of the inverter element 12 corresponds to a heat-dissipating surface and the seating surface 6a remains covered by the insulator 50 and insulation member 40 without being exposed to the outside so that problems caused by foreign matter entry and pollutions are prevented, thereby facilitating uniform heat dissipation at all times.

FIG. 8 shows that the underside of the fixing member 30 according to the present embodiment extends in a cone shape unlike the previous embodiment. The cone-shaped extension of the fixing member 30 may increase the contact area with the motor housing 20.

The fixing member 30 is configured with the underside extending horizontally for contact with the motor housing 20 so that heat may be stably conducted through contact.

According to the embodiments of the present disclosure, a structural change of the fixing member simultaneously allows stable fixation of the inverter elements and heat conduction to the low-temperature motor housing as well as securing of the insulation distance of the inverter elements, thereby achieving the improved insulation effect and heat dissipation effect.

According to the embodiments of the present disclosure, the inverter unit and the electric compressor including the inverter unit may secure the withstand voltage performance to ensure stability and minimize damage and malfunction of the high-cost inverter elements.

According to the embodiments of the present disclosure, foreign matters may be prevented from entering the insulation member, and uniform surface pressure on a plurality of inverter elements may be maintained.

Those skilled in the art to which the present disclosure pertains may modify or change the present disclosure in various ways by way of supplementing, changing, deleting, or adding components within the scope not deviating from the idea of the present disclosure described in the patent claims. It is to be noted that all such modifications fall within the scope of the rights of the present disclosure.

The embodiments may be used in electric compressors equipped with inverter elements.

1-20. (canceled)

21. An inverter unit comprising:
a plurality of inverter elements mounted on a seating surface of an inverter housing;
a fixing member partially inserted into a motor housing via the plurality of inverter elements and the inverter housing to fix the plurality of inverter elements to the seating surface individually; and
an insulation member coupled to the fixing member and subsequently inserted into the inverter housing.

22. The inverter unit of claim 21, wherein the fixing member includes a step portion stepped radially inward.

23. The inverter unit of claim 22, wherein the step portion is positioned above the inverter housing in a state where the fixing member is mounted in the inverter housing.

24. The inverter unit of claim 23, wherein an underside of the fixing member extends horizontally.

25. The inverter unit of claim 23, wherein the insulation member includes a body portion forming an overall appearance and a protrusion portion extending from an upper side of the body portion via a topside of the inverter housing to be coupled to the fixing member and subsequently engage the step portion.

26. The inverter unit of claim 25, wherein the protrusion portion extends radially outward to a first insulation thickness t to secure insulation distance.

27. The inverter unit of claim 25, wherein an insulator is provided between each of the plurality of inverter elements and the inverter housing, and the upper side of the body portion remains in surface contact with an underside of the insulator.

28. The inverter unit of claim 21, the inverter housing further comprising:
a first insertion hole into which the fixing member is inserted;
an extension portion extending to a predetermined length from an underside of the inverter housing toward the motor housing relative to the first insertion hole and including a first thread formed inside; and
a first groove portion into which the insulation member is inserted.

29. The inverter unit of claim 28, wherein the extension portion extends beyond an underside of the fixing member.

30. The inverter unit of claim 29, wherein a second thread engaging the first thread of the extension portion in helical coupling is formed in the fixing member.

31. The inverter unit of claim 28, wherein the motor housing includes a second groove portion into which the inverter housing and the extension portion are inserted.

32. An electric compressor comprising:
a housing;
a motor portion provided in the housing;
a compressor unit provided with a compression unit driven by the motor portion; and
an inverter unit coupled to the compressor unit, wherein the inverter unit includes an insulation member coupled to a fixing member, partially inserted into a motor housing via a plurality of inverter elements and an inverter housing, and subsequently inserted into the inverter housing to fix the plurality of inverter elements mounted on a seating surface of the inverter housing to the seating surface of the inverter housing individually.

33. The electric compressor of claim 32, wherein the fixing member further comprises a step portion stepped radially inward.

34. The electric compressor of claim 33, wherein the insulation member further comprises:
a body portion forming an overall appearance; and
a protrusion portion extending from an upper side of the body portion via a topside of the inverter housing to be coupled to the fixing member and subsequently engage the step portion.

35. The electric compressor of claim 34, wherein the protrusion portion extends radially outward to a first insulation thickness t to secure an insulation distance.

36. The electric compressor of claim 34, wherein an insulator is provided between each of the plurality of inverter elements and the inverter housing, and the upper side of the body portion remains in surface contact with an underside of the insulator.

37. The electric compressor of claim 32, wherein the inverter housing includes:
a first insertion hole into which the fixing member is inserted;
an extension portion extending to a predetermined length from an underside of the inverter housing toward the motor housing relative to the first insertion hole and including a first thread formed inside; and
a first groove portion into which the insulation member is inserted.

38. The electric compressor of claim 37, wherein the extension portion extends beyond an underside of the fixing member.

39. The electric compressor of claim 37, wherein a second thread engaging the first thread of the extension portion in helical coupling is formed in the fixing member.

40. The electric compressor of claim 37, wherein the motor housing includes a second groove portion into which the inverter housing and the extension portion are inserted.
